(19) United States
(12) Patent Application Publication
(10) Pub. No.: US 2026/0286206 A1
(43) Pub. Date: Sep. 24, 2026

(54) SELF HEATING MATERIAL

(71) Applicant: The Aerospace Corporation, El Segundo, CA (US)

(72) Inventors: Henry HELVAJIAN, Pasadena, CA (US); Eric Joseph NEMANICK, Santa Monica, CA (US); Adon DELGADO, Jr., West Hills, CA (US)

(73) Assignee: The Aerospace Corporation, El Segundo, CA (US)

(21) Appl. No.: 19/086,481

(22) Filed: Mar. 21, 2025

(51) Int. Cl. C09K 5/18

(52) U.S. Cl. CPC C09K 5/18

(57) ABSTRACT

A method for manufacturing self-heating material (SHM) via radioisotopes includes determining a target heat temperature needed for an intended device or material operating in its relevant environment. The SHM may include structural/fluidic/paste/fluidic/paste. The method also includes determining a number of radioisotopes for a SHM of the intended device based on the radioisotopes and an area of the SHM. The method further includes infusing the radioisotopes within the SHM to form the SHM, wherein the SHM is configured to serve as a heat source.

### FIELD

The present invention generally pertains to heating, and more particularly, to self-heating of structural and fluidic and/or deformable materials for efficient operation in their relevant environment, such that heat is provided where needed.

### BACKGROUND

To provide context, the example of a spacecraft is used to present the idea. Thermal regulation in spacecraft depends on the mission. Typically, spacecraft employ physical “shutters” or heat pipes to regulate heat. Both solutions can deplete on-board electrical power reserves. In missions where solar radiation is nil (e.g., deep space, Lagrange points like Earth-Sun L2) or where one wants to minimize the thermal emission signature (e.g., security missions) electrical heaters are used to keep key subsystems operating (e.g., electronics, propellant fuel, batteries, etc.). This also depletes on-board power reserves. This is also true for enclosures on the Moon or Mars for housing astronauts or equipment (i.e. instruments).

For large spacecraft, designers use the thermal capacity of the spacecraft mass as a thermal storage “battery” to minimize large temperature cycling. While this is viable for large, massive spacecraft, it becomes more challenging for small mass satellites (e.g., microsatellite and CubeSat/nanosatellite class spacecraft), and again electrical heaters are employed, at the detriment of the limited-on board power generation, to keep key subsystems operational.

Another space-based example is a space mission where periodic high mobility maneuvers are necessary. To maneuver, propellant fuel must be expended which requires that the fuel propellant pressure and temperature to always be maintained, and again electrical heaters are used, which causes a continual electrical drain to on board power resources. In addition, all these heaters and heat pipes are add-on devices. These add-on devices affect the structural/fluidic/paste dynamics and mechanics of a spacecraft system in addition to adding more mass.

Other examples include motion systems or machinery operations (i.e., robots, rovers, any instrument that uses a motor or driver to instigate motion whether rotary, sliding, linear or complex). The interfaces where the surfaces are moving or sliding against each other on bearings or simple contact are susceptible to stiction at low temperatures. Heaters are used to maintain these surfaces at a high enough temperature to overcome stiction forces and permit efficient motion. The insertion of heaters makes these motion systems more complex; in addition, there is a drain on power resources, and the introduction of a physical heating element could limit operational mobility.

Another example is for surfaces or interfaces that operate at a particular temperature range, in general above that of the environment, but the interface or surface is neither moving nor structural/fluidic/paste (e.g., plumbing tubes, circuit boards, “cooling tubes”). The movement of fluids through or over these surfaces or materials requires a certain minimum temperature for the fluids which in the absence of this invention requires resistive heaters.

In one example, the environment's temperature varies over time and so must the amount of heat supplied at these interfaces. For this example, heaters are used with the capability to vary the amount of heat supplied. In this example, physical attachment of heaters adds complexity, produces a drain on power resources and for some cases (miniature or complex shape) the insertion of a physical entity for heating may not even be possible. In this final case, the heaters are installed farther away but then there is the issue of affecting other nearby parts/components from excessive heating.

Accordingly, an alternative approach may be beneficial.

### SUMMARY

Certain embodiments of the present invention may provide solutions to the problems and needs in the art that have not yet been fully identified, appreciated, or solved by current electric heater technology. For instance, some embodiments of the present invention pertain to self-heating material (SHM) for electric heaters. SHM may include self-heating structural material, self-heating fluidic material, self-heating paste, and/or self-heating deformable material.

For purposes of explanation, a radioisotope material composite (RMC) may be defined as an entity having the form of a pellet, granule, or powder form. The RMC encapsulates a concentration of radioisotope substance that has been pulverized from its production state. The encapsulation material, which can be composed of several layers comprising of multiple materials, serves at least the following purpose. First, the encapsulation material is intended to reduce the radiation produced by the radioisotope for safe handling. Second, the encapsulation material is intended to efficiently convert the emitted radioisotope radiation to heat and ensure that the emitted heat is isotropic. Lastly, the encapsulation material is intended to be compatible with the host material when mixed to form the SHM.

In an embodiment, a method for manufacturing SHM via radioisotopes includes determining how much heat is required for an intended device or material during operation in a given environment. The method also includes determining the size for each RMC and amount of heat produced by each RMC pellet, powder, bead. The method further includes selecting the size for each RMC based on a manufacturing or infusing technology to make the device infused with or coated with SHM.

In another embodiment, a method for manufacturing SHM via radioisotopes includes determining how much heat is required for an intended device or material during operation in a given environment. The method also includes determining the size for each RMC and amount of heat produced by each RMC. The determining size includes selecting the size for each RMC and a radioisotope concentration therein. The method further includes selecting the size for each RMC based on a manufacturing or infusing technology to make the device infused with or coated with SHM.

In yet another embodiment, a method for manufacturing SHM via radioisotopes includes determining how much heat is required for an intended device or material during operation in a given environment. The method also includes determining size for each RMC and amount of heat produced by each RMC, and determining a target heat equilibrium temperature by determining a radioisotope type. The method further includes selecting the size for each RMC based on a manufacturing or infusing technology to make the device infused with or coated with SHM.

In yet a further embodiment, a SHM configured to serve as a heater and a functional element may include a structure or spacecraft material infused with heat granules to maintain temperature of one or more surrounding elements within operational range. The heat granules are configured to heat the structure or the spacecraft material while allowing the structure or the spacecraft material to serve its intended purpose.

In yet another embodiment, a SHM configured to serve as a heater and a functional element includes a structure or spacecraft material infused with heat granules to maintain temperature of one or more surrounding elements within operational range. The heat granules are configured to heat the structure or the spacecraft material while allowing the structure or the spacecraft material to serve its intended purpose.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While these drawings depict only typical embodiments of the invention and are not therefore to be considered to be limiting of its scope, the invention will be described and explained with additional specificity and detail through the use of the accompanying drawings, in which:

FIG. 1 is a flow diagram illustrating a method for dispersing radioisotopes in the form of RMC units to produce a SHM, according to an embodiment of the present invention.

FIG. 2 is a flow diagram illustrating a method for producing/manufacturing self-heating material based on RMC material, according to an embodiment of the present invention.

FIG. 3 is a diagram illustrating a self-heating material configured to serve a dual purpose, i.e., a heater and a functional element for its intended as a structural purpose, according to an embodiment of the present invention.

FIG. 4A is a diagram illustrating a self-heating material configured to serve a dual purpose, i.e., a heater and a functional element for its intended as a structural material purpose manufactured via additive manufacturing technique, according to an embodiment of the present invention.

FIG. 4B. is a diagram illustrating a self-heating material configured to serve a dual purpose, i.e., a heater and a functional element for its intended as a structural material purpose manufactured via cast manufacturing technique, according to an embodiment of the present invention.

FIG. 4C. is a diagram illustrating a self-heating material configured to serve a dual purpose, i.e., a heater and a functional element for its intended as a structural material purpose manufactured via a fiber production manufacturing technique, according to an embodiment of the present invention.

FIG. 5 is a diagram illustrating a self-heating material configured to serve a dual purpose, i.e., a heater and a functional element for its intended purpose as a paste or fluidic material, according to an embodiment of the present invention.

FIG. 6A is a diagram illustrating a self-heating material configured to serve a dual purpose, i.e., a heater and a functional element for its intended purpose in a rotary motion system, according to an embodiment of the present invention.

FIG. 6B is a diagram illustrating an application of a self-heating material configured to function in a rotary motion system, according to an embodiment of the present invention.

FIG. 6C is a diagram illustrating a self-heating material configured to serve a dual purpose, i.e., a heater and a functional element for its intended purpose in a linear motion system, according to an embodiment of the present invention.

FIG. 6D is a diagram illustrating an application of a self-heating material configured to function in a linear motion system, according to an embodiment of the present invention.

### DETAILED DESCRIPTION OF THE EMBODIMENTS

For purposes of explanation, some embodiments described herein use the example of a spacecraft because spacecraft systems reside in the cold space (requiring heat) and temperature regulation. In those cases where solar radiation cannot be used for regulation, electrical heaters are employed. As discussed above, electrical power is a limited and valuable commodity and adding heating elements, unless necessary, is frowned because of the added mass and its relation to the cost of launch.

Spacecraft's use electricity to produce local thermal power for maintaining temperature regulation onboard. For example, there are instances when the spacecraft spends time away from the Sun or when the spacecraft travels to the outer reaches of the solar system where the Sun's effects are minimal.

Rather than using or adding electrical heating elements and deal with electrical wiring and harnesses to deliver electrical power to the heater, as well as drain the spacecraft power system, some embodiments incorporate within the structure of the material small amounts of treated radioisotopes (i.e., in the form of grains or pellets) to maintain temperature of the surroundings within the operational range. The radioisotope density (gm/cm³), or in the manufacturing of the structure, the density of RMC material is determined from thermal modeling of the area. The thermal modeling of the area takes into consideration the desired operational temperature, the amount of heat the radioisotope pellet/grain emits, and the temperature of the surroundings where heat is being removed. This can be accomplished whether the SHM is structural/fluidic/paste or deformable.

In the case where the amount of necessary heat is varied depending on the task or time, a concentration of RMC within a fluid is used with heat deposition varied with the fluid flow rate. Treated radioisotopes or RMC material, in this case, may refer to encapsulation of the isotope material in a non-permeable shell, coating, matrix, or dispersion within another material, to prevent migration of the isotope material to other areas that pose health hazards, impose deleterious effects on electronics or other systems, or otherwise negatively impact external systems.

Radioisotopes are atomic elements in which their nuclear structure is unstable. Radioisotopes undergo fission reaction to release energy by emitting α (He nucleus, +2 charge), β (electron, −1 charge), and γ (high energy photon) radiation. Gamma (γ) rays are most powerful (i.e., energetically) while Beta (β) particles can penetrate skin causing burns. α radiation can be stopped by a single sheet of paper (20 lbs.), and will not penetrate the skin, while β and γ emitters pose human safety issues when handling, α emitters can be handled under safe conditions. Three radioisotopes have attributes relevant to this concept because they have a long half-life (HL) and are commercially available in various amounts (e.g., ²⁴¹Pu, HL=14.4 years, ²⁴¹Am, HL=432 years, ⁹⁰Sr, HL=28.8 years). Plutonium is used in nuclear weapons development. Americium is used in smoke alarms and Strontium is used in medicine and agriculture. Of the three, Americium-241 is primarily an α emitter, with some low keV γ emission that can be shielded by 300 μm thick platinum shielding, making it safer for human handling if it is not ingested. Americium 241 primarily decays to Neptunium 237, another transuranic isotope with a half-life of 2.1 million years (also an Alpha emitter). Americium is found in the environment in microscopic dust or from the decay of Plutonium-241. The maximum radiation dose from a 160 g sample of Americium-241(with no platinum cladding) over 100 hours and at 1 m distance is 0.004 Gy (SI unit, Gray). Platinum cladding reduces this dose by a factor of 10. The annual dose limit for radiation workers is 0.05 Gy. In some embodiments, for space applications where spacecraft carrying self-heating structures undergo atmospheric re-entry (at end of life) atmospheric, re-entry temperatures are 2700 K, Americium-241 melts at 1449 K and boils at 2880 K. Consequently, there is little likelihood of self-heated structure surviving orbit re-entry and making it to the ground.

Heating of a structure and surroundings via embedded radioisotope is through energy transfer from the energetic emitted radiation impacting the host material. Structures and materials produced incorporating these isotopes may feel warm are not a radiation hazard. The radiation is primarily captured by the surrounding material, leaving only minimal radiation to escape to the surrounding objects. These types of structures are defined as SHM.

Radiation emitting isotopes are used in spacecraft as power sources (e.g., Radioisotope Thermoelectric Generator (RTGs)). While RTG's employ the radioisotopes in a compact and clumped “hockey-puck” shapes, in this embodiment, the radioisotope is dispersed or encapsulated within the SHM in the form of an RMC, such that the overall temperature of the produced part maintains its temperature at a particular operating temperature. Structures or components incorporating these isotopes or RMCs at defined concentrations calculated from thermal designs are “self-heaters”. At selected concentrations, the SHM may come to an equilibrium with its environment to maintain a working temperature on the spacecraft and at the location where it is used.

Radioisotopes are generally produced, transferred and packaged in oxide form (e.g., AmO_{2,} PuO₂). In these embodiments, the radioisotope oxide is further processed into pellet or granule forms (~mm or less) and then packaged as a RMC (as defined above). This approach not only permits better means of dispersal into the host material but also better characterizes and makes uniform the specific amount of heat (Q) produced per unit volume.

The heat produced by the decay of the radioisotope flows, which is inside the RMC, into the host material, which incorporates it. To reduce any anisotropic heat flow out of the AmO₂ granule, for example, the granules are further encapsulated within a ceramic or metallic (e.g., platinum) shell. The shell material not only permits more uniform (i.e., isotropic) heat conduction but also reduces the amount emitted radiation (e.g., β, γ) leaving the host material.

In some embodiments, the particles are encapsulated in high temperature oxide such as Cerium Oxide. For example, the particles are encapsulated within a 50 micron coating of oxide such as Cerium Oxide. This coating is viewed as a shell, in some embodiments. The ceramic or coating may be of any material that is compatible with the host material, and the metal may be any metal that is compatible with the host material.

In the example of a satellite, a SHM (which may be composed of structural, fluidic, or paste material) may be composed of metal alloys, carbon composites or high temperature polymers (i.e., could be a deformable material) and RMC. In the case of a variable heating application, the SHM may be composed of helium gas, water or other fluid media carrier (i.e., working fluid) and RMC.

An example of a material design is a propellant container of a carbon composite material that incorporates pellets/granules of an RMC based on ²⁴¹AmO₂ radioisotope in the carbon composite. The ²⁴¹AmO₂ is in particulate form, with particle sizes around 1 mm in diameter or less, and encapsulated in a high temperature cerium oxide coating forming an RMC. The emission of alpha particles from the ²⁴¹AmO₂ may interact with the cerium oxide to generate heat, and this heat is transferred to the carbon composite host material. The mixture maintains its target temperature at a location based on reaching equilibrium with its relative temperature environment. The amount of ²⁴¹AmO₂ (incorporated in the RMC) in the carbon composite depends on the size of the RMC, its thermal environment (e.g., cold space), and the local heat transfer properties including that of radiation (i.e., thermal emission). The concentration density of radioisotope in the RMC granules is calculated a priori, in a design step, where the target temperature is reached based on the thermal output of a distribution of RMC pellets based on ²⁴¹AmO₂ radioisotope granules versus the heat lost to the environment.

Some embodiments pertain to the need for a SHM. In some embodiments, the SHM (e.g., metal alloys, carbon composite) serves a dual role-material and a local heater, in the case of a design where the environment is very cold (e.g., in outer space, or on the Moon, or in Antarctica).

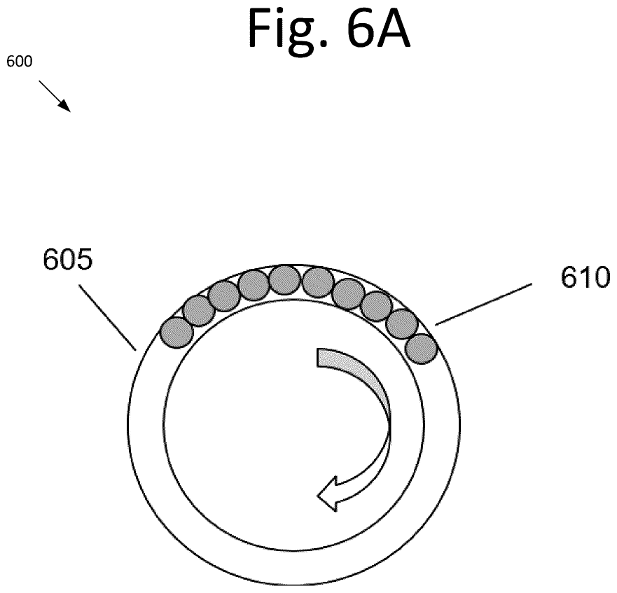

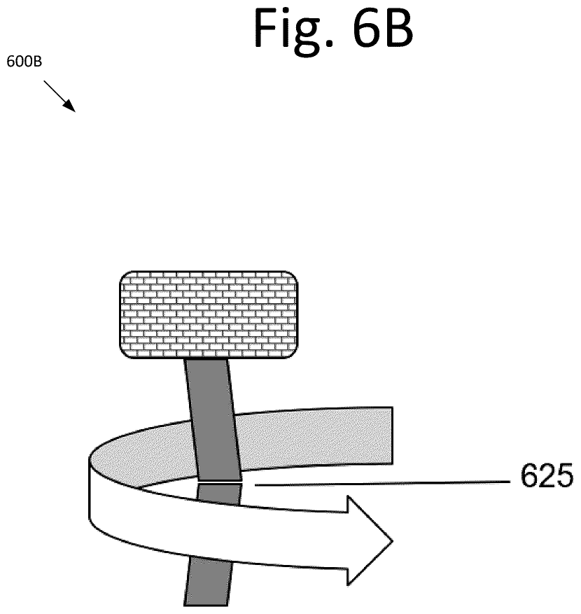

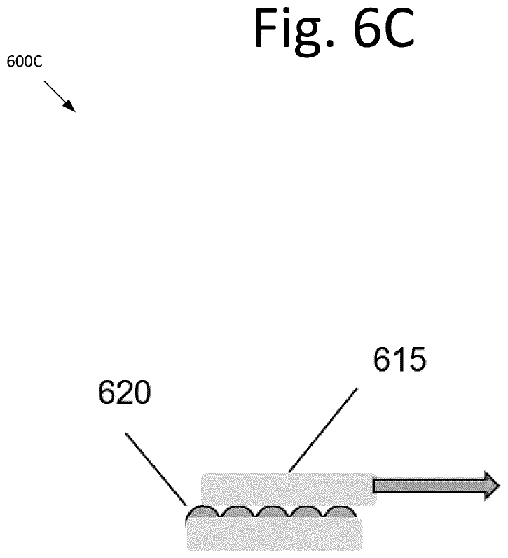

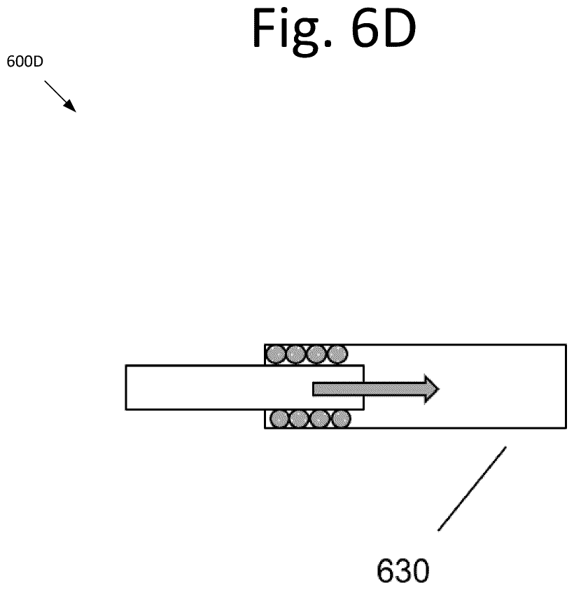

Using the space application for example to further explain another embodiment, future lunar missions may include several rovers or robots (e.g., robotic arms) in space, whether they are on the ground on the Moon, on Mars or are in space. These motion systems require some warmth to keep from freezing up. Cold metal welding is known as a solid-state welding or contact welding process-a detrimental result for a motion system. The example that comes to mind is space antenna booms freezing. The freezing usually occurs at the critical motion joints limiting the extension, rotation of the booms and the overall antenna may become inoperable because of less than adequate deployment. Another example includes any motion systems that use ball bearings and raceways (i.e., to reduce friction in motion). See, for example, FIGS. 6A and 6C. The bearings are always in contact with the raceway, a little bit of self-heating in the raceway or in the bearing may minimize the contact welding processes. See, for example, FIGS. 6B and 6D for examples of application.

Currently, heaters are placed at critical points on the spacecraft, the rover, or more specifically, on the antenna boom. With this placement, the antenna boom design becomes more complex and prone to failure. The amount of heat necessary is deduced from thermo-physics models where the amount of supplied heat (supplied by local radioisotopes/RMC density) is balanced (at the equilibrium temperature) by the outside surface temperature to arrive at a local working temperature. The analysis takes into consideration the amount of heat released per unit volume (based on the number pellets/granules deposited per unit volume) and the conductivity (i.e., thermal properties) of the host material and the amount of surface area that is in contact with another surface at a different temperature.

The analysis dictates the amount of (radioisotope) pellets/granules that should be placed or inserted per unit volume during the manufacturing process. The primary driving equations are 1) the heat equation that describes heat flow, and 2) the Stefan Boltzmann Law (equation) that describes the total thermal radiant heat power emitted from the surface. For non-vacuum applications where there is a working fluid (e.g., gas, liquid, plasma), the equations also include other heat transport equations (e.g., convection conduction, plasma). Commercial thermal modeling/simulation tools (e.g., Thermal Desktop (SINDA/FLUINT), TSS, COMSOL, Ansys, SimScale) are available that generate temperature profiles, in both steady state and/or time resolved given a computer assisted design (CAD) model of the structure. The tools may also require the material thermophysical properties, the heat content (Q), and thermal radiative surface area (from CAD model). The heat output (Q) from a radioisotope source volume has been investigated by many and to great detail. For example, for Americium-241 it is 0.1 Wₜₕ/g, Strontium-90, 0.27 Wₜₕ/g and for Plutonium-238 0.5 Wₜₕ/g.

There are several design parameters to calculate the amount of radioisotope or RMC integration into the accepting host material to form a SHM. Parameters include the type of radioisotope material, the encapsulation material (i.e., to form the RMC), the type and properties of the accepting material (i.e., host material), mission application, radioisotope type and RMC granular size and distribution, material conductivity, thermal radiation heat transfer, and the desired operating temperature range. Thermal simulation models may generate an overall effective thermal conductivity and heat generation per volume given a density of RMC entities within the host or accepting material. Conduction, convection (if applicable) and thermal radiation heat transfer are used in calculating the RMC density in the material for the desired range of temperature for the application. Numerical modeling using analytical, finite difference, finite volume, and or finite element methods are used to create computer models to optimize the design to meet the thermal mission requirements.

In some embodiments, the SHM may be composed of polymer, resin, or composite material containing RMCs based on radioisotopes of alpha emitters, the amount of RMC heat sources must be such that the local temperature is kept below the transition temperature of the material (e.g., polymer breakdown, polymer glass forming temperature where the polymer transitions from a rubbery state to a rigid state). The intent is to keep the deformable properties of the intended device.

The concentration of the RMC particles within the SHM is designed such that the ultimate equilibrium temperature at the desired location would be within the target temperature range of the application. The concentration may be more than 20 weight (Wt.) percent. Consider the example of a box that contains a particular type of spacecraft battery. The battery should be maintained at a narrow temperature range for the battery to function. Using this example, if the battery enclosure loses 15 Watts of thermal energy, the battery enclosure over time normally causes the battery to rapidly cool below its effective operating temperature. These 15 Watts of thermal energy are replaced by incorporating an RMC material based on ²⁴¹AmO₂ into the SHM that makes up the structure of the battery box or container. The ²⁴¹AmO₂ may supply 15 Watts of thermal energy (in this case, by having 150 grams of ²⁴¹Am in the form of an RMC dispersed in the carbon composite material that is used to construct the battery box. This may result in the battery maintaining its temperature, balancing isotope heat generation against thermal losses to the environment.

These calculations are performed for any component within a spacecraft or structure that is placed and operated in a cold temperature environment. The analysis is done using, for example, conventional computer thermal models. Computer models have been developed to simulate the thermal heat transfer response of the integrated radioisotope/RMC or a heat (Q) (in Wₜₕ/g) into the host material. These parametric models optimize the amount of radioisotope/RMC in the volume of the host for a given temperature range. If, for example, the structure is manufactured layer by layer as in 3D manufacturing, it may be possible to tailor the RMC density in the overall structure shape. The density/concentration of the RMC in the host SHM solid/liquid or gas depends on the desired temperature range and on the host SHM's application (e.g., structural/fluidic/paste, electronic box, spacecraft outer skin, carrier fluid material, etc.).

It should be appreciated that for every application of SHM (and the desired equilibrium temperature to be maintained), a thermal calculation model and simulation provides the guidance on the pellet/granule density and whether it is uniformly dispersed or placed locally in clumps. This is regardless of whether the SHM is for a battery box, avionics box, a gear or a gear system, a sensor, or a telescope, to name a few.

The above paragraphs present an embodiment for SHM produced heat being used to maintain a constant temperature of systems, materials, components housed within the SHM or in contact with the SHM structure. The embodiment given is the desire to keep a battery/power source warm. Using the example of the battery/power source, one of ordinary skill in the art can reason that, if the enclosure was a physical structure and not an SHM but wrapped with tubing that transfers a SHM in fluidic form, such person of ordinary skill in the art would be able to alter the amount of heat transferred to the box by varying the flow rate of the fluidic material. Thus, it would be possible to have a structure maintained in a non-constant temperature.

In the example of the battery, prior to launch, the temperature on Earth could be made compatible with the battery specifications. Once, in orbit, an SHM fluid could flow to compensate for far colder temperatures of space. There are other examples, on Earth or in space where the capability to alter the temperature profile as needed would be useful. In cold climates, however, a car engine prior to a start is cold but after running the temperature of the car engine heats up. Similarly, water plumbing must be kept warm during severe winters so as not to freeze trapped water, but extra heating is not necessary when the ambient temperature is well above freezing.

Material properties in mechanical systems include compliance, brittleness, bulk and flexural modulus, plasticity, toughness, yield strength; in electrical systems include conductivity, pyroelectricity, permittivity, capacitance, dielectric strength; and in chemical systems include reactivity, corrosion resistance, surface mobility for Acoustic (e.g., speed of sound, sound reflection). The temperature dependent equations for each of the listed properties are documented herein.

Some examples of embodiments include 1) in mechanical systems, when conducting automated assembly of multiple components, temperature is often used to change the plasticity, compliance or flexural modulus of the components in order to establish a fit. One of ordinary skill in the art may foresee a design where one of components is SHM material that produces heat to establish a fit. In this embodiment, the SHM may be a fluidic material, and upon fitting, the fluid flow is stopped, and the material returns to equilibrium temperature.

In another example embodiment, 2) in electrical systems, conductivity in metals decreases with increasing temperature, while in semiconductors, conductivity increases. Metals with low electrical conductivity (high electrical resistance) are Tungsten, Mercury, Titanium, Lead, Stainless steel and Carbon steel to name a few. An SHM structure based on these metals may make them even more resistant to electrical flow. For example, heating elements in appliances. An SHM heating element may draw less current to reach the same ultimate temperature.

In yet another embodiment of SHM based on metals. Electrometers, microammeters, insulation testers and other instruments use very high electrical resistance values (e.g., 1M or 10M ohm) as the load. The key to precise measurement is the stability of the load resister. The ambient temperature of these instruments may vary as they are moved from spot to spot. By using a SHM based resistor, the temperature may be set above any anticipated environmental temperature fluctuations, and therefore, render the resistor stable along with the measurement instrument.

In yet another example embodiment, 3) in chemical systems temperature plays profound role in reactivity, mixing and in surface mobility of atomic/molecular species (e.g., chemical vapor deposition). This is because chemical reactions are determined by the laws of thermodynamics and the activation of energy. This is true for atomic, molecular, polymer and enzyme reactions. In many systems that are driven by catalytic activity, the reaction rate is increased when the catalytic material is hot.

In an embodiment, solid oxide fuel cells (SOFCs) and high-temperature proton exchange membrane fuel cells operate with more efficiency at elevated temperatures. SOFCs can produce electricity to power homes, ships and transportation systems. In such embodiments, the ceramic elements in the SOFCs may be SHM material increasing the total temperature between to a typical operating range of 600-1000 C quickly, without the need for external heating. The ceramic used in SOFCs do not become electrically and ionically active until they reach very high temperature. Consequently, current SOFCs take a long time to come up to temperature. With an SME material integrated into the system, the time for generating electricity is reduced. In these embodiments, the SHM may be the ceramic materials used or another material that is in contact with ceramic materials and thereby altering the properties.

In certain embodiments, a method for creating a self-heating material through the distribution of RMCs across the SHM. The SHM may serve as a heat source and simultaneously have another purpose beyond its original design. In this embodiment, a uniform dispersion of the pellets/granules produces a homogenous SHM that has uniform temperature across a large area or volume. This could be a large panel, an extruded long beam/pole, a 3D printed material block. These could be panels to be used in lunar habitats, panels that maintain a plant growth garden (in space, on the Moon, Mars, etc.).

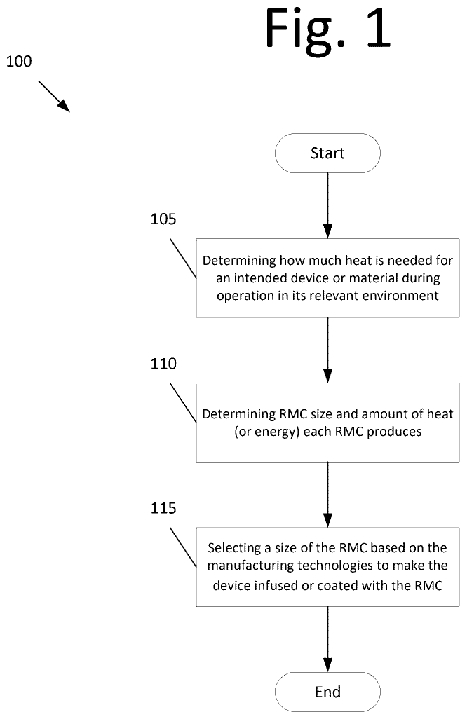

FIG. 1 is a flow diagram illustrating a method 100 for dispersing radioisotope material (RMC) in a SHM, according to an embodiment of the present invention. In an embodiment, method 100 may begin at 105 with determining how much heat is needed for the intended device or material during operation in its relevant environment. At 110, determine RMC size and amount of heat (energy) each RMC produces. This is determined by selecting the size of RMC and the radioisotope concentration therein. At 115, the size of RMC is selected based on the manufacturing (infusing) technology to make the SHM device infused/coated with the RMC. In some embodiments, the amount of radioisotope material, which is needed to be placed in an RMC pellet/granule/powder based on the RMC given the area/volume of the SHM to be heated, determined. In certain embodiments, thermal calculation simulation tools based on the CAD of the overall system guide as to the concentration of RMCs to be placed locally.

For purposes of explanation, a radioisotope is defined as the fundamental element from the periodic table that undergoes nuclear decay by fission, and RMC is defined as radioisotope material composite as an entity having the form of a pellet, granule, or powder form. The RMC encapsulates a concentration of radioisotope substance that has been pulverized from its production state. The encapsulation material, which can be of multiple layers comprising multiple materials serves at least the following purpose. First, encapsulation material is intended to reduce the radiation produced by the radioisotope for safe handling. Second, encapsulation material is intended to more efficiently convert the emitted radioisotope radiation to heat and ensure that the emitted heat is isotropic. Third, encapsulation material is intended to be compatible with the host material when mixed to form a SHM.

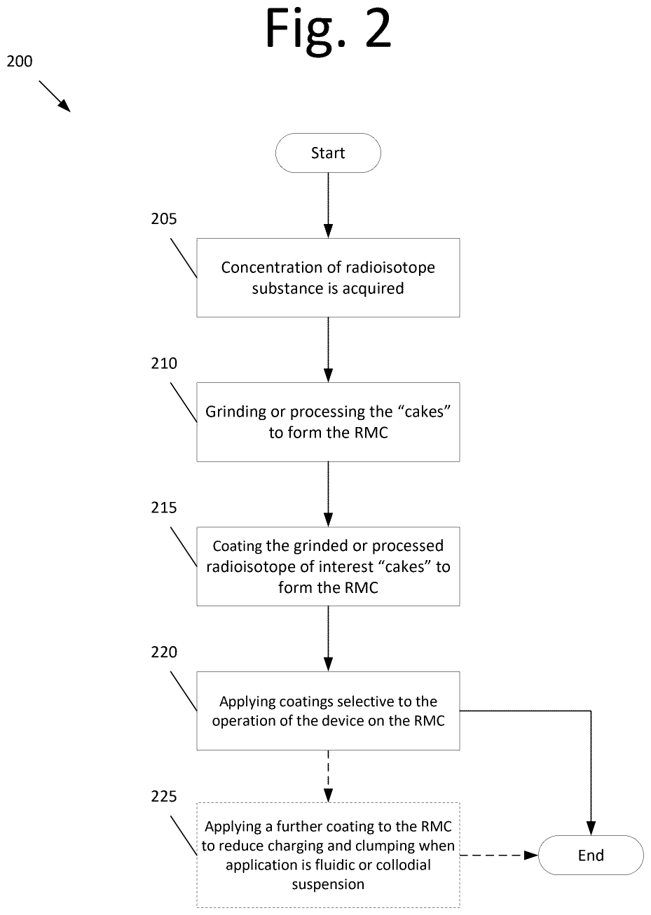

In certain embodiments, FIG. 2 is a flow diagram illustrating a method for producing RMCs. At 205 of method 200, a concentration of radioisotope substance is acquired. This concentration of radioisotope substance may have been pulverized from its production state (e.g., as oxides and in “cake” or hockey puck form). At 210, method 200 includes grinding or processing the “cakes” to form RMC. At 215, method 200 includes coating the grinded or processed “cakes” (i.e., the radioisotope of interest) to form the RMC.

At 220, method 200, in some embodiments, and depending on the application, the RMC has coatings that (a) make it compatible to be infused in the host SHM mixture, (b) reduce the radiation output from the radioisotope, and (c) to ensure that the heat output from each processed material is isotropic.

At 225, method 200 includes if the application is for fluidic, colloidal suspension or paste application, a further coating is applied to the RMC to reduce charging and clumping.

The thermal modeling simulation tools (e.g., Thermal Desktop, COMSOL etc.), which comprise the CAD drawing of the intended device within the overall system in operation, can calculate how much heat Q TOTAL is needed to supply at a local area/volume to maintain a desired temperature. From experimental determination (examples given above), the amount Q produced by each isotope substance is known (Wₜₕ/gm). Furthermore, the amount of heat emitted for an RMC of particular size and coating overlayers is also experimentally derived. Consequently, knowledge of Q TOTAL needed per unit volume along with the knowledge of Q emitted per RMC in grain/pellet/powder form per unit volume, the local concentration RMC (gm/cm3) can be calculated.

Working fluids (e.g., any fluidic substance, including gas and plasma) are typically used to remove heat from a local area. However, there are applications where there is need to provide heat to an area via a working fluid. Let's use water pipes in buildings that are in environments where the temperate plummets to below freezing, as an example. In this example, if the water is not circulating, common knowledge is to pipe out the water to keep the pipes from bursting (i.e., an attribute of water which expands when frozen). In some embodiments (such as in closed water/fluidic systems), it may be cost effective to produce and maintain a warm working fluid without applying heat via electricity.

An alternative would be to provide a SHM plumbing, which may not be feasible or too costly to retrofit. Another example where the use of SHM (fluidic) would be of use is in areas where the amount of heat to be provided can be throttled or varied. For example, a cold engine that needs heat to start but during operation it generates sufficient heat for its purposes. In this example, the temperature required of the target environment changes and the use of SHM where it is possible to titrate out the RMC concentration would be possible.

In another example, heat rejection systems may use fluids, which may freeze in lunar and deep space missions. Using SHM in radiator manifolds and/or radiator panels may prevent freezing of the primary fluid in a pumped fluid loop system (PFLS). This idea may also work in radiator designs with manifolds and heat pipe radiator panels.

To summarize, the preparation of pellets or powder for manufacturing SHM based on RMCs may follow several manufacturing processes. However, the goal is to take the radioisotope substance material (typically in the form of oxide “cakes”) and grind the “cakes” or process the “cakes” into pellets, beads or powder form. Upon grinding or processing the “cakes”, the pulverized material is coated to minimize radioisotope radiation (alpha, beta and gamma) release. The coated material enables safer handling during the manufacturing of the self-heated structure.

In general, the manufacturing of SHM may be envisioned as a process similar to doping of semiconductors in microelectronics (i.e., selected area) or mixing of ingredients when cooking (i.e., global). Step-by-step details of the preparation process, in certain embodiments and examples are given below.

### Grinding Process

There are multiple manufacturing technologies that grind radioisotope material to produce pellets, beads or powders. These tooling are used, for example, in additive manufacturing (AM) technologies (e.g., to make powders), energy industry (e.g., to make pellets), ablative blasting industry (e.g., to make beads), coating industry (to make powders, beads). The radioisotope stock material is ground to produce a quantity of pellets, beads or powder depending on the process for the self-heated material. The grinder tooling should limit the generation of spurious materials to maximize the purity of the ground material.

### Filtering Process

The produced stock of pellets, powders or beads are filtered to separate spurious materials and then sized by the filtering process. The ground RMC stock material should be size filtered to better control the emitted heat flux per self-heated material volume.

### Coating Process

The sized RMC stock is coated with a ceramic or metal coating (e.g., a 50-100 thick micron of metal) to reduce high energy emissions (alpha, beta, gamma) from the radioisotope elements.

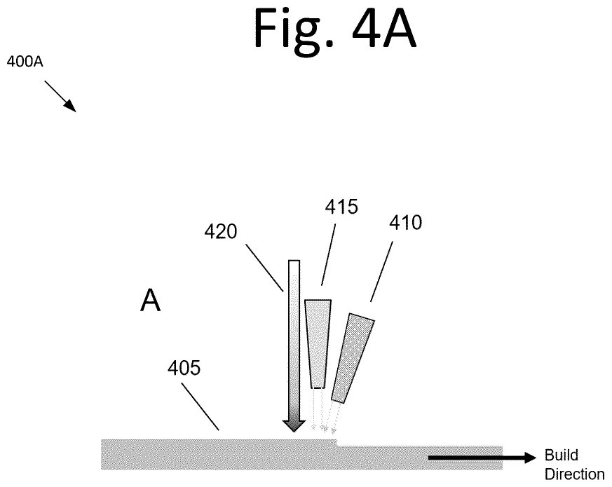

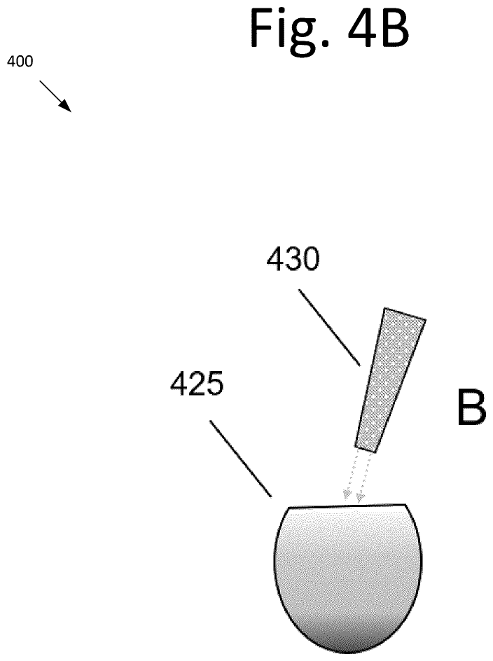

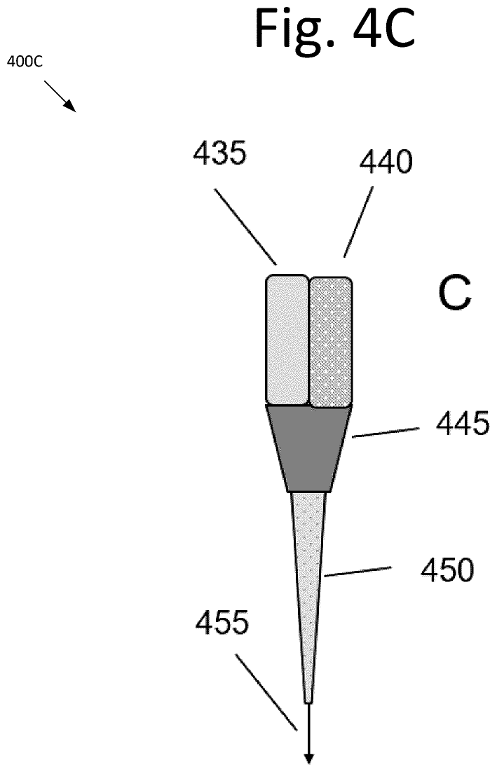

Certain embodiments may use different admixing approaches depending on the SHM to be produced. For example, metal or ceramic additive manufacturing (AM) may mix the RMC-powder with AM powder for 3D AM. This is similar in the case for making SHM out of glasses. The glass host SHM is admixed with RMC powder or small beads. In the case of beads or pellets, they are admixed with host or base SHM. In producing glass fibers an extrusion device (e.g., spinnerets) are used (see FIG. 4C).

For SHM, such as carbon fiber composites, the RMC material is mixed with the resin or material. In embodiments that use carbon fiber carbon or ceramic composite, the RMC material would be in the matrix material (e.g., graphite or ceramic matrix).

The concentration of RMC powder/pellet/bead at any one location of a SHM produced structure is determined a priori from a thermal analysis tool of the modeled part to be manufactured taking into consideration the desired operational temperature of the part when the part is placed onto the real physical environment. The calculations use equations for heat transfer given a known distribution of small heat sources (the RMC beads, powder or pellets). The heat transfer equation parameters depend on the thermal properties of the self-heated host material and the RMC material.

In some embodiments, the SHM is in the form of a paste that has SHM granules therein. However, in other embodiments, a fluid is used that serves as the carrier of the self-heating granules. In both embodiments, the concentration of the SHM per unit volume of paste or fluid is such that it does not raise the local temperature to break down the host material of the paste or induce a phase transition in the liquid host. Moreover, the self-heating granules should be coated with anti-charging material to minimize charge induced clumping.

These embodiments allow for the development of a SHM that is multifunctional (i.e., heater+structural/fluidic/paste), which can be safely handled. Additionally, these embodiments solve the problem of the need to provide heating on spacecraft, especially those spacecrafts with little mass without imposing burden on the onboard power source. There is no need to add-on additional heater systems. The multifunctional material, as described, can also be used in other applications where structural/fluidic/paste heating is necessary to keep it above the ambient environment temperature (e.g. Moon, Antarctica, under a glacier, pipes and fittings that routinely transport cryogenic liquids (e.g., liquid nitrogen, oxygen)).

In another embodiment, providing local heating as per the SHM concept is used to produce a desired temperature profile on a surface, in a volume. Heat flows by conduction, convection and by thermal radiation. In the case of thermal radiation, as in vacuum, the local temperature is also related to the local temperature which is also related to the wavelength of thermal radiation. The higher an object's temperature, the shorter or smaller the wavelength of the thermal radiation (e.g., Wien's law). Consequently, by patterning the deposition of SHM within a surface, a tapestry of thermal emissions along with associated wavelengths is produced. An example of the utility of this thermal emission tapestry is it could serve as a “signature”, like a “flag” identifying the owner or user. The tapestry need not be the whole structure, but one corner if necessary.

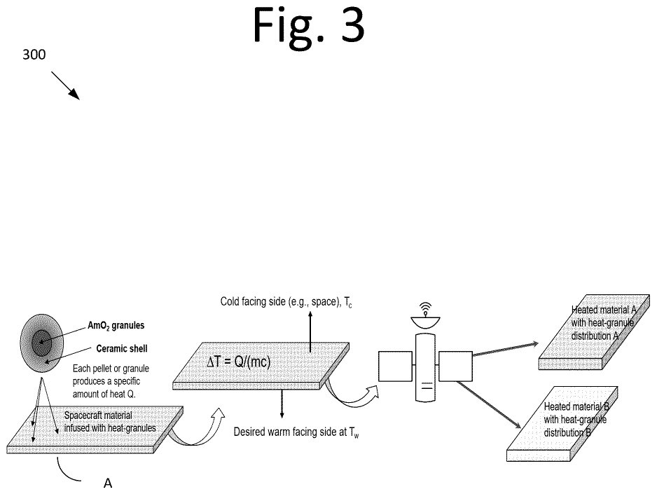

FIG. 3 is a diagram illustrating a SHM 300 configured to serve a dual purpose, i.e., a heater and a functional element for its intended purpose, according to an embodiment of the present invention. In some embodiments, SHM 300 provides both structural/fluidic/paste support as normally intended and a local heat source. In these embodiments, alpha radiation emitting isotopes (or radioisotopes) are dispersed into SHM 300. See element A.

In FIG. 3, an RMC based on Americium 241 (Am²⁴¹) has a half-life of 432 years and Polonium 209 (Po²⁰⁹) has a half-life of 102 years may be used. It should be appreciated that radiation emitting isotopes are typically produced as oxides (e.g., AmO₂), and each pellet (i.e., mass weight g) or granule produces a specific amount of heat Q. In this embodiment, there is a cold-facing side (e.g., space), and a designed warm facing side (i.e., the desired temperature of the functional element in it is operational environment).

FIG. 3 also shows heat material A with heat-granule/powder/pellet distribution A and heated material B with heat-granule/powder/pellet distribution B. It should be appreciated that the two different heat distribution materials, could be large (e.g., meter scale,) small (e.g., centimeter scale) or micro (e.g., <1 mm scale) and a structure that has a full 3D tapestry of heat distribution A or B or other can be produced by existing manufacturing technologies (e.g., additive manufacturing technology).

FIGS. 4A-C are diagrams illustrating SHM 400A-C configured to serve a dual purpose, i.e., a heater and a functional element for its intended as structural purpose, according to an embodiment of the present invention. In these embodiments, FIGS. 4A-C show RMC infusion into SHM (FIG. 4A) AM technology, (FIG. 4B) traditional furnace manufacturing, and (FIG. 4C) fiber production technologies. In FIG. 4A, valved nozzle or RMC delivery system 410 in carrier gas, liquid or paste is shown, and valved nozzle or host material delivery system 415 is shown. At 420, directed energy system for fusing host and RMC material forms a SHM.

In FIGS. 4B, 430 shows an RMC delivery, system applied to a furnace with mixing 430 is the RMC delivery and 425 is the blast furnace. In FIG. 4C, a resin or host delivery system 435 or RMC material delivery system 440 with a spinneret 445 is shown. At 450, multiple filaments are mixed comprising of host material and RMC and applied to formation of a self-heating fiber 455.

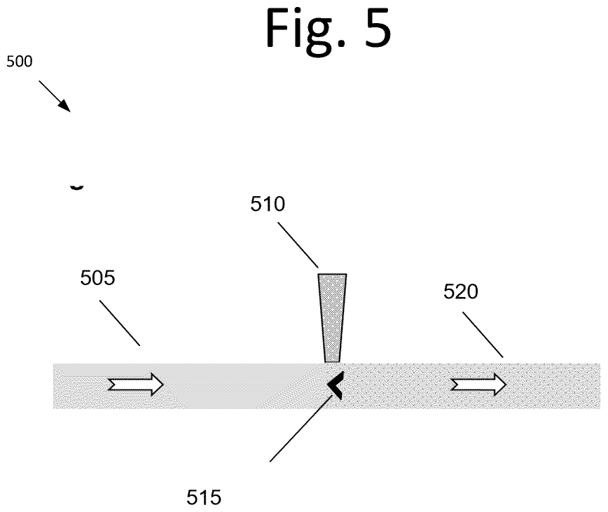

FIG. 5 is a diagram illustrating a SHM 500 configured to serve a dual purpose, i.e., a heater and a functional element for its intended purpose as a liquid or paste, according to an embodiment of the present invention. In this embodiment, SHM 500 is an example of RMC infusion into a fluidic housing where the fluid direction is shown by the arrow. 505 shows a fluidic housing with an RMC dispenser 510 above. 515 (e.g., static mixer) shows internal structure for enhancing mixing of RMC into fluid, and 520 is the self-heating liquid material where the RMC may be in colloidal suspension.

FIGS. 6A-D are diagrams illustrating a SHM 600A-D configured to serve a dual purpose, i.e., a heater and a functional element for its intended purpose as a rotating or linear translation structure, according to an embodiment of the present invention. In these embodiments, SHM 600A-D show examples of ball bearing packed raceways used in motion systems.

In FIGS. 6A and 6B, raceway 605 is shown for a rotary motion system that can produced from SHM, ball bearings 610 in raceway that can also be produced from SHM. In operation, 625 shows an application of a rotating joint to position a sensor, solar cell, lights, etc.

In FIGS. 6C and 6D, shown are linear raceway motion system 615 that can be produced from SHM, and a ball bearing 620 in linear raceway that can also be produced from SHM. 630 shows an application of an extending boom using the linear raceway motion system 615 and the ball bearing 620 for extension purposes.

It will be readily understood that the components of various embodiments of the present invention, as generally described and illustrated in the figures herein, may be arranged and designed in a wide variety of different configurations. Thus, the detailed description of the embodiments of the present invention, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. To determine the metes and bounds of the invention, therefore, reference should be made to the appended claims.

1. A method for manufacturing self-heating material (SHM) via radioisotopes, comprising:
determining how much heat is required for an intended device or material during operation in a given environment;
determining size for each radioisotope material (RMC) and amount of heat produced by each RMC; and
selecting the size for each RMC based on a manufacturing or infusing technology to make the device infused with or coated with SHM.

2. The method of claim 1, further comprising:
determining a target heat equilibrium temperature by determining a radioisotope type.

3. The method of claim 1, wherein the determining size comprises selecting the size for each RMC and a radioisotope concentration therein;

4. The method of claim 1, further comprising:
determining a target heat equilibrium temperature by determining the radioisotope type and concentration within an RMC along with the size of RMC, wherein the RMC is in the form of pellets, granules or powder.

5. The method of claim 1, further comprising:
determining a heat equilibrium temperature for the RMC.

6. The method of claim 4, further comprising:
determining a local concentration of the RMC for the SHM, wherein
the determining the local concentration of the RMC comprising
calculating an amount of RMC integration into the SHM.

7. The method of claim 1, further comprising:
acquiring the radioisotope from a corresponding source material, wherein the source material is oxide cakes or other compound; and
grinding or processing the radioisotope to form a plurality of pellets, beads, or powders.

8. The method of claim 7, wherein the infusing the radioisotopes within the SHM comprises
coating the radioisotope to form RMC plurality of pellets, beads, or powders and infusing RMC onto the host material to form the SHM.

9. The method of claim 8, wherein the coating of the plurality of pellets, beads, or powders comprising
uniformly dispersing of the plurality of pellets, beads, or powders to produce the SHM with uniform temperature across an area or volume of the SHM.

10. The method of claim 1, further comprising:
providing, using a thermal calculation model and simulation, guidance on density of a plurality of pellets, beads, or powders; and
identifying areas where the plurality of pellets, beads, or powders are uniformly dispersed or placed locally in clumps.

11. A method for manufacturing self-heating material (SHM) via radioisotopes, comprising:
determining how much heat is required for an intended device or material during operation in a given environment;
determining size for each radioisotope material (RMC) and amount of heat produced by each RMC, wherein the determining size comprises selecting the size for each RMC and a radioisotope concentration therein; and
selecting the size for each RMC based on a manufacturing or infusing technology to make the device infused with or coated with SHM.

12. The method of claim 11, further comprising:
determining a target heat equilibrium temperature by determining a radioisotope type.

13. The method of claim 11, further comprising:
determining a target heat equilibrium temperature by determining the radioisotope type and concentration within an RMC along with the size of RMC, wherein the RMC is in the form of pellets, granules or powder.

14. The method of claim 11, further comprising:
determining a heat equilibrium temperature for the RMC.

15. The method of claim 13, further comprising:
determining a local concentration of the RMC for the SHM, wherein
the determining the local concentration of the RMC comprising calculating an amount of RMC integration into the SHM.

16. The method of claim 11, further comprising:
acquiring the radioisotope from a corresponding source material, wherein the source material is oxide cakes or other compounds; and
grinding or processing the radioisotope to form a plurality of pellets, beads, or powders.

17. The method of claim 16, wherein the infusing the radioisotopes within the SHM comprises
coating the radioisotope to form RMC plurality of pellets, beads, or powders and infusing RMC onto the host material to form the SHM.

18. The method of claim 18, wherein the coating of the plurality of pellets, beads, or powders comprising
uniformly dispersing of the plurality of pellets, beads, or powders to produce the SHM with uniform temperature across an area or volume of the SHM.

19. The method of claim 11, further comprising:
providing, using a thermal calculation model and simulation, guidance on density of a plurality of pellets, beads, or powders; and
identifying areas where the plurality of pellets, beads, or powders are uniformly dispersed or placed locally in clumps.

20. A method for manufacturing self-heating material (SHM) via radioisotopes, comprising:
determining how much heat is required for an intended device or material during operation in a given environment;
determining size for each radioisotope material (RMC) and amount of heat produced by each RMC;
determining a target heat equilibrium temperature by determining a radioisotope type; and
selecting the size for each RMC based on a manufacturing or infusing technology to make the device infused with or coated with SHM.

21. A self-heating material (SHM) configured to serve as a heater and a functional element, comprising:
a structure or spacecraft material infused with heat granules to maintain temperature of one or more surrounding elements within operational range, wherein
the heat granules are configured to heat the structure or the spacecraft material while allowing the structure or the spacecraft material to serve its intended purpose.

22. The SHM of claim 21, wherein the heat granules are composed polymer, resin or composite material containing radioisotopes material based on radioisotopes of alpha emitters.

23. The SHM of claim 22, wherein a concentration of the radioisotope material particles within the SHM is more than zero weight (Wt.) percent.

24. The SHM of claim 22, wherein a density of the radioisotope material is determined from thermal modeling of a desired operational temperature range, amount of heat the radioisotope emits, temperature of the one or more surrounding elements where heat is being removed.

25. The SHM of claim 22, wherein the radioisotope material comprises of an isotope material encapsulated in a non-permeable shell, coating, or matrix of dispersion within another material.

26. The SHM of claim 25, wherein the non-permeable shell, coating, or matrix of dispersion within another material prevents minimal radiation to escape to surrounding areas.

27. The SHM of claim 21, wherein the heat granules are encapsulated within a ceramic or metallic shell to reduce anisotropic flow out of the heat granules.

28. The SHM of claim 27, wherein the ceramic or metallic shell is configured to allow uniform heat conduction and reduce an amount of emitted radiation from the structure.
